(19) United States
(12) Patent Application Publication
(10) Pub. No.: US 2001/0048365 A1
(43) Pub. Date: Dec. 6, 2001

(54) Intrusion alarm for swimming pool

(76) Inventor: Greg McFarand, Staten Island, NY (US)

Correspondence Address: OSTROLENK FABER GERB & SOFFEN, 1180 AVENUE OF THE AMERICAS, NEW YORK, NY, 100368403

(21) Appl. No.: 09/764,472

(22) Filed: Jan. 17, 2001

Related U.S. Application Data
(60) Provisional application No. 60/176,835, filed on Jan. 19, 2000.

(51) Int. Cl. G08B 23/00

(52) U.S. Cl. 340/573.6; 340/552; 340/573.1

(57) ABSTRACT

An apparatus for detecting an object in a pool of liquid has at least one transmitting transducer for generating one of a sonic, ultrasonic and electromagnetic signal into the pool of liquid from a side of the pool of liquid and such that the signal is conveyed through the entire volume of the pool of liquid; at least one receiving transducer for receiving an echo of the signal transmitted by the transmitting transducer; and a circuit coupled to the transmitting and receiving transducers for providing an electrical signal to the transmitting transducer to generate the signal and for receiving an electrical signal from the receiving transducer indicative of the echo, the circuit including a processor for processing the signal indicative of the echo to determine if an object is present in the pool of liquid. In one embodiment, the circuit determines a time window for a first echo signal to be received after reflection off a wall of the pool of liquid and detects a second echo signal before receipt of the first echo signal if an object is present in the pool of liquid. In a second embodiment, the circuit comprises a fish finder type sonic/ultrasonic object locator.

### CROSS REFERENCE TO RELATED APPLICATION

This application claims the priority and benefit of U.S. provisional application Serial No. 60/176,835 filed Jan. 19, 2000 and entitled “INTRUSION ALARM FOR SWIMMING POOLS”, the disclosure of which is hereby incorporated by reference.

### BACKGROUND OF THE INVENTION

The present invention relates to alarm devices for detecting if a foreign object has fallen into a body of water, for example a swimming pool. In particular, the invention is directed to detecting if a small child has fallen into a swimming pool and sounding an alarm in such an event.

A number of devices have been conceived for detecting if objects fall into swimming pools, in particular, if children fall into swimming pools. For example, U.S. Pat. Nos. 5,144,285, 5,049,859 and 3,810,146 show a type of swimming pool alarm apparatus in which a transmitter must be worn on a child in order to set off the alarm if the child enters the water. Although such devices are very effective and are not subject to false alarms, they have the significant disadvantage that they will not detect a child that has fallen into a pool that is not wearing the transmitter.

Other alarm devices for pools have also been conceived including, for example, the swimming pool alarm of U.S. Pat. No. 4,121,200 which depends upon water disturbance created by a person in the swimming pool for detection and the device of U.S. Pat. No. 5,023,593 which uses passive infrared and acoustic sensors for detecting if a person has fallen into a pool. An infrared detector detects heat and the acoustic element detects waves generated as the body struggles at or below the water surface. Also see U.S. Pat. No. 5,091,714 which uses a hydrophone to detect acoustic noises when a person falls in a pool.

Typical of devices which do not require that a transmitter be worn by a person and which rely on ultrasonic or electromagnetic signals are U.S. Pat. No. 5,369,623 to Zerangue and U.S. Pat. No. 5,638,048 to Curry. The Curry patent utilizes sonar, lidar or radar to detect if an object has fallen in a pool and discloses a means for preventing false alarms due to self-interference and also due to wind activated waves. Although apparently a useful device, the Curry device suffers from a short-coming in that it may not be able to detect the presence of a foreign body in the corners of the pool nearest the transmitting and receiving transducers because the comers of the pool may not be within the signal cones produced by the transmitting transducer. Curry shows an example in FIG. 9 of his patent using two transmitting and two receiving transducers, but it is believed that this arrangement also suffers from the same problem due to the spacing of the transducers.

The Zerangue reference utilizes a plurality of transducers mounted on a support which send and receive acoustic energy into the water of the swimming pool and a control means for activating a transducer to generate a series of pulses from the transducers and a means responsive to changes in the reflected echo pattern received at one of the transducers before the expiration of a pre-determined time period and thus indicative of a foreign object in the transmission path for generating an alarm. Essentially, Zerangue relies on receiving an echo pulse from the foreign object in the pool before the expiration of a predetermined time period. Zerangue relies on a complex device requiring a plurality of spaced transducers. See FIG. 3 of Zerangue.

There are also known various devices using sonar for the detection of fish in bodies of water, i.e., so-called fish finding apparatus. An example is described in U.S. Pat. No. 5,184,330.

### SUMMARY OF THE INVENTION

The present invention resolves problems presented by the prior art swimming pool alarm systems. In one embodiment, the present invention utilizes transmitting/receiving transducer elements at opposite ends of the pool. The pool can be square, rectangular, circular or oval and may even have some other shape, for example, an irregular shape. By using transducers at two opposed ends, it is assured that the entire volume of the pool is subject to the transmitted energy which is preferably sonic (ultrasonic-sonar) energy, but which can also be electromagnetic energy (e.g., radar, lidar). In this way, for example, even the corners of a rectangular pool adjacent the transducer are covered by the energy of the oppositely placed transducer so that if a foreign object falls into that area, it will be detected. According to another embodiment, if the pool is rectangular or square, the transducer is placed in the corner, and the beam angle (preferably 90°) of the energy transmitted into the pool is arranged so that the energy is transmitted to all regions of the pool.

According to another aspect of the invention, technology available in the fish finding art may also be used to determine the presence of a foreign object in the pool. The object of a swimming pool intrusion detection apparatus is that it be able to detect that an object has fallen into the water. It is not necessary to determine the location in the swimming pool of the object as is required by fish finding apparatus to determine the location of fish, nor is it necessary to use the doppler effect to determine that an object is moving.

### BRIEF DESCRIPTION OF THE DRAWINGS

FIG. 1 shows an arrangement of transducers in a pool according to one embodiment of the invention;

FIG. 2 shows a prior art transducer arrangement;

FIG. 3 shows how the invention covers an entire pool using two transducers;

FIG. 4 is a block diagram of a circuit according to the invention;

FIG. 5 shows another arrangement of transducers in a pool;

FIGS. 6 and 7 are flow charts illustrating the operation of the invention; and

FIG. 8 shows another embodiment of the invention.

### DETAILED DESCRIPTION OF THE PREFERRED EMBODIMENTS

According to one embodiment of the invention, the crucial item of intelligence to be obtained from the return signal is that the return signal from the pool walls is received after an echo from an object in the pool, and this knowledge is used by the invention in order to set a time window for receipt of an echo signal from an object in the pool. However, the invention can also use the doppler effect to determine that an object is moving.

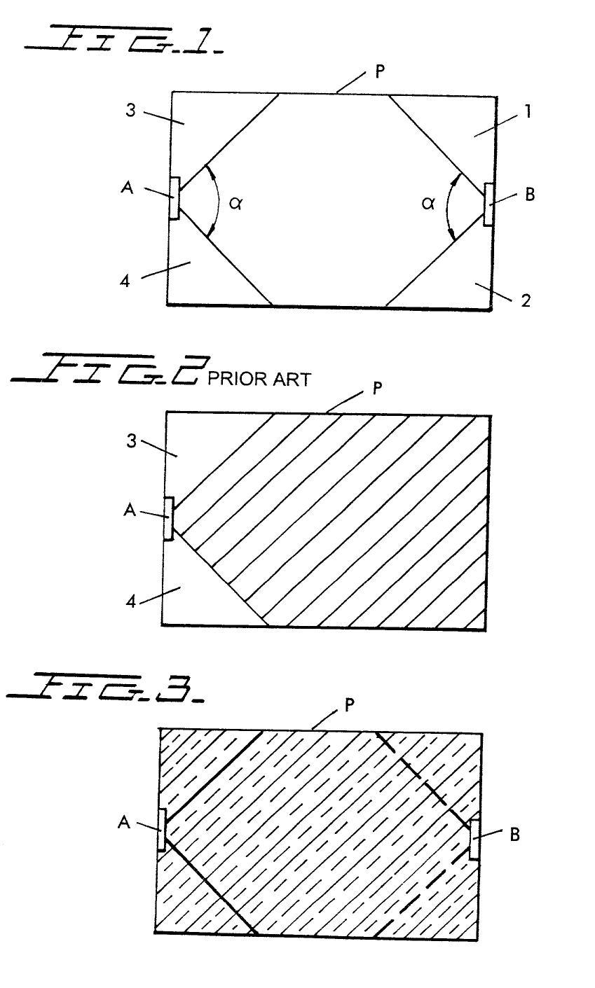

FIG. 1 shows an exemplary arrangement according to one embodiment of the invention of how two transducers A and B can be arranged in a pool P. The pool P is shown in a top plan view. Each transducer A and B preferably comprises a transducer used as both a receiving and transmitting transducer coupled to a duplexer so that the same transducer can be used for both reception and transmission as well known to those of skill in the art. As shown, each transducer has a beam angle ∝ in which it is able to transmit and receive energy into the pool. Preferably the transducer is ultrasonic or acoustic. However, it may also be an electromagnetic transducer/receiver i.e., for example, using radar or light energy. As shown, two transducers A and B are used. In this way, the energy from transducer A reaches to the corners 1 and 2 of the pool and the energy from transducer B reaches to the corners 3 and 4 of the pool. The reflected echo of the energy produced by a transducer is received during a reception phase by the same transducer. Preferably, the two transducers A and B are fed with energy of different frequencies and filters are employed in the receiver circuit so that only energy of the frequency produced by that transducer is processed in the receiver circuit for that particular transducer. In this way, the energy produced by transducer B will not interfere with the processing of information received from transducer A and vice versa.

FIG. 2 shows the problem encountered with prior art apparatus, for example, devices like that shown in the Curry patent U.S. Pat. No. 5,638,048. As shown, using a single transducer positioned as shown, like in the Curry patent, will cause the corner areas 3 and 4 of the pool near the transducer to be uncovered, thus potentially allowing a small child to drown in the corners before the alarm signal is generated.

FIG. 3 shows that by using the two transducers A and B, the entire volume of the pool is covered. The solid lines show the area covered by transducer A and the dashed lines show the area covered by transducer B.

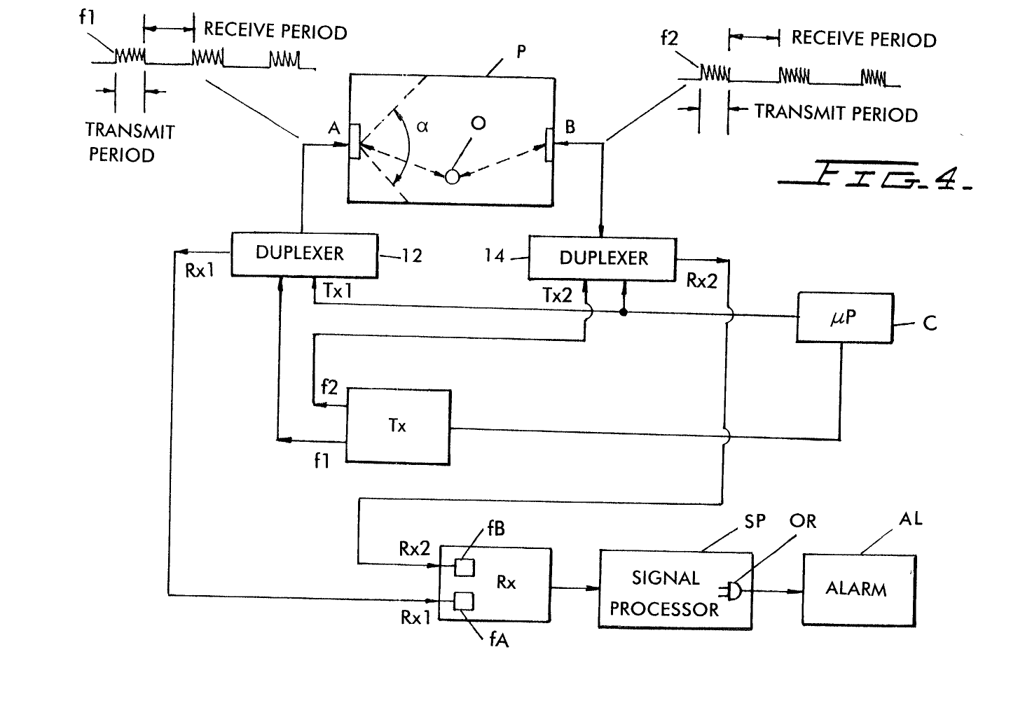

FIG. 4 shows an example of a block diagram of a circuit which can be employed using the two transducers A and B. An object O is shown in the pool P. The pool P is shown in a top plan view as in the other drawings.

Each transducer A and B transmits pulsed energy of a specified frequency and pulse repetition rate in a specified beam angle. The angle for transducer A is shown by ∝. The frequency contained in each pulse may be ultrasonic,, e.g., 50 kHz and the pulse repetition rate is determined to be such that pulses are spaced sufficiently to allow a reflected return pulse to be received before the next pulse is transmitted. A signal generator TX provides two different frequency signals f1 and f2. Frequency f1 is provided through a duplexer 12 and frequency f2 is provided through a duplexer 14. As discussed, f1 and f2 are preferably ultrasonic. The duplexers 12 and 14 are controlled by suitable control apparatus, preferably comprising a microprocessor controller C. Each duplexer provides a transmit signal to the respective transducers A and B. The signals are transmitted into the pool and if there is no object in the pool, only the return signal from the walls of the pool is received during the receive period. The received reflected signal is received by the respective transducer and duplexer 12 and 14 and provided as a receive signal RX1 and RX2 to the receiver circuit RX. Each transducer has a transmit period and a receive period, as controlled by generator Tx under control of control circuit C. The receiver circuit RX includes two filters fA and fB to filter out unwanted signals. In particular, filter fA filters out all signals except those signals at the frequency f1 of the receiving signal RX1. Filter fB filters out all signals except those f2 of the receiving signal RX2. Basically, filter fA filters out all signals except frequency f1 and filter fB filters out all signals except frequency f2.

The outputs of the receiver circuit Rx comprising the two signals from the two filters fA and fB are provided to the signal processor SP. The signal processor SP determines if the signals received are received within a predetermined time window and may perform other signal processing functions, e.g., analyzing for doppler effect and/or characteristics of the return signal to discriminate the type of object.

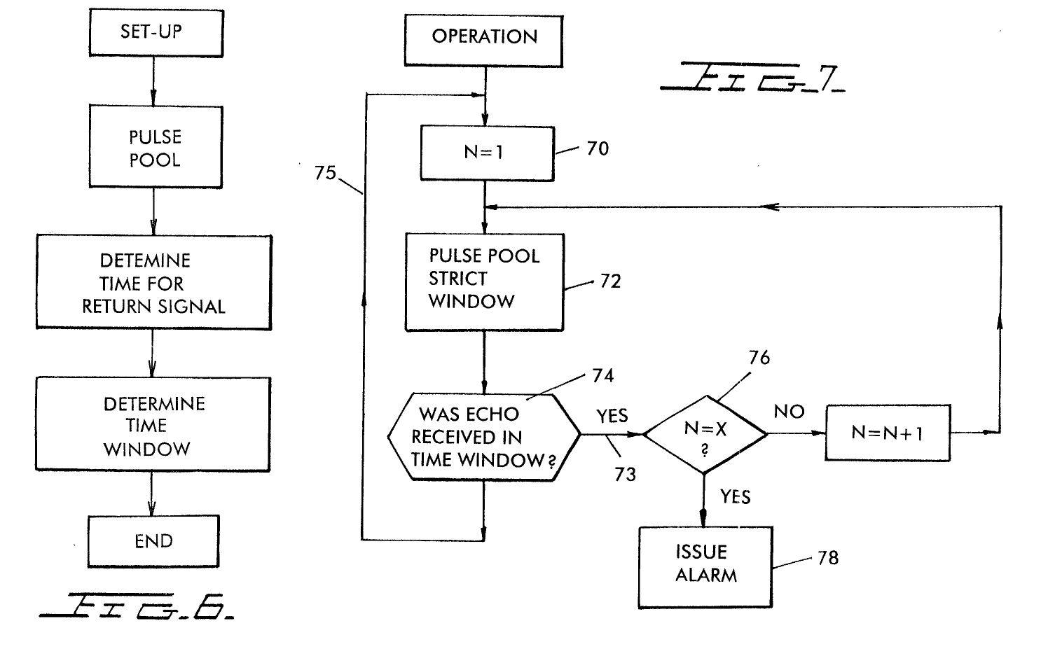

The time window is determined on setup of the device. FIG. 6 shows how the time window is automatically determined. With no objects in the pool, the time for each pulse to be received based on reflection off the pool sides is determined. It is assumed that a reflection from an object will be received sooner, since such reflection will be returned without requiring reflection off the most distant pool wall. FIG. 7 shows how the signal processor SP determines if an alarm is to be generated. At step 70, a counter is initialized to 1. At step 72, a pulse is transmitted into the pool and the time window is started. At step 74, the signal processor determines whether an echo signal was received during the time window. If no, see line 75, another pulse is transmitted and the count is again set to 1. If an echo was received during the time window (73), the counter is checked to see if it equals a predetermined number of counts X. If there are a predetermined number of counts X, meaning the echo signal has been received in the time window for the predetermined number of counts X, then the alarm is generated at 78. The number X is based on the pulse repetition rate of the transmitted signal and the sonic propagation velocity in water, for an ultrasonic or sonic system. The higher the pulse repetition rate, the larger X can be. This improves the reliability of the device and prevents alarm triggering based on interference. However, adequate time must be left between pulses for the return signal to be received.

Since an echo signal from either transducer A or B is sufficient to require the alarm to be sounded, the signal processor may employ an OR circuit OR (FIG. 4) so that if either transducer A or B provides an echo signal in the time window for the required count, the alarm will be sounded. If the object is near the center of the pool, both transducers A and B will provide a signal indicating that an object is in the pool. If the object is in the comers of a rectangular pool, however, only one of the transducers may provide such a signal. Once the signal has been detected, an alarm AL will be triggered.

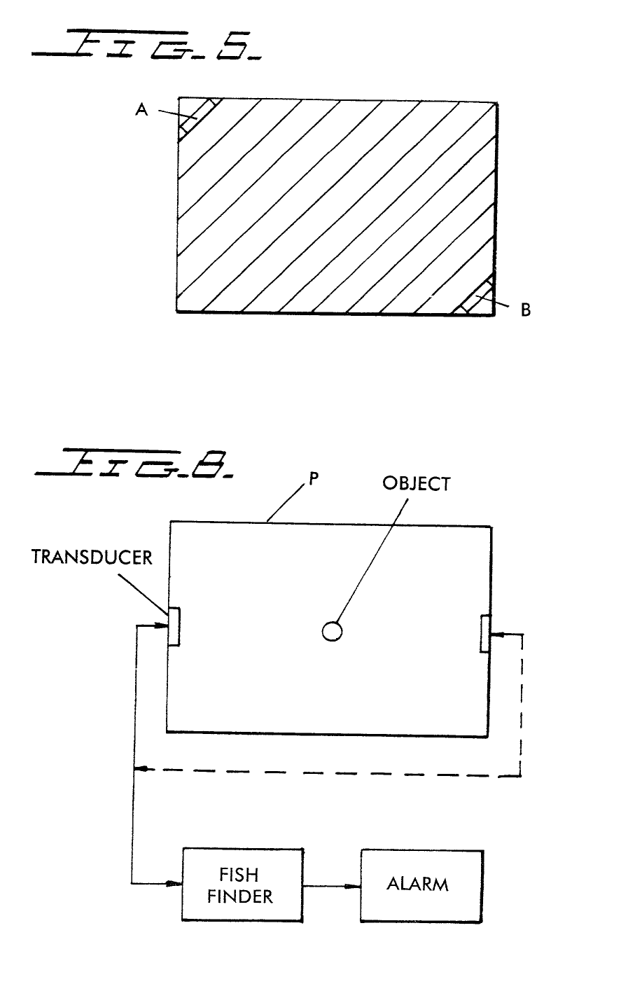

According to a further aspect of the invention, it is possible to use only one transducer A provided at a comer of a rectangular pool. The beam angle of the transducer is selected as 90°, and thus the entire volume of the pool can be covered by a single transducer placed at a comer. However, depending upon the length of the pool, it may be preferable to provide two transducers A and B arranged as shown in FIG. 5.

Although FIG. 4 shows the transducers A and B each comprising both a receiving and transmitting transducer and utilizing a duplexer, a person of skill in the art should realize that two transducers can be used for each transducer A and B so that a separate transmitting and receiving transducer is provided at each location A and B. In such an arrangement, it will be unnecessary to utilize duplexers 12 and 14 and the output from each receiving transducer is provided to the receiver circuit RX at the appropriate frequency input.

Further, in the embodiment shown in FIG. 5, if only a, single transducer A is used, it is unnecessary to employ a signal generator Tx providing two output frequencies or a receiver having two filters fA and fB.

Further, although the disclosed embodiment looks for an echo signal during a time window (which time window is determined by the device of the invention, i.e., it adapts to the size of the body of water automatically), according to another embodiment, the invention can employ a signal processor of the fish finding art to discriminate a return echo signal from an object in the pool from an echo signal reflected off the pool walls. This can be done using the techniques known from the sonar and fish finding art. Using such techniques, it is not necessary to look for echoes only during a certain time window prior to the echo being received from the pool walls. For example, a scanning sonar can be used to provide a plurality of scans, and based on the return echo from each scan, the distance to the object can be determined, analogously to the “depth” determination of a fish finder. That is, using a fish finder type of device, a foreign object can be discriminated from the return echoes from the pool walls and thus a determination can be made that an object has fallen into the pool. In essence, a fish finder type of device is being used sideways to look into the pool water parallel to the surface of the pool instead of perpendicularly to the surface. Although reference is made to a scanning sonar, the invention can also employ a non-scanning type of sonar. In essence, any known device from the fish finding art for discriminating objects from background signals and noise can be employed. Thus, software that has been developed to make a decision that a reflection represents an object as opposed to noise, background reflections off the pool wall, waves in the pool, etc., can be employed to make a decision that the return signal represent an object, and therefore to provide an alarm.

Further, the transducers may produce alternating scans, as known to those of skill in the art of sonar and fish finding devices. For example, the sonar may be a so called scanning sonar alternating between narrow and wide beams, particularly to cover objects falling below the surface.

FIG. 8 shows an example of swimming pool intrusion apparatus using a fish finding device. The fish finder device may, for example, use a signal processor to discriminate the size of the object based on the reflection from the object and to reject background signals (reflection off the pool wall, which is analogous to reflection off the sea floor), cross talk noise and other noise. See, for example, U.S. Pat. No. 5,930,200 to Kabel. Any known technique from the fish finding art can be used, according to the present invention, to distinguish a reflection from a foreign object from other reflected signals emanating from the pool walls and noise. Since the device according to the invention does not require an actual determination and display of distance, the modified fish finding device employed can be less complex. There is, e.g., obviously, no need for a display device. Upon the determination that a foreign object is present based on any of the known fish-finding techniques, and after elimination of noise and interference, an alarm is provided. The alarm can be audible or visual, or both, for example.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. Apparatus for detecting an object in a pool of liquid comprising:
at least one transmitting transducer for generating one of a sonic, ultrasonic and electromagnetic signal into the pool of liquid from a side of the pool of liquid and such that the signal is conveyed through the entire volume of the pool of liquid;
at least one receiving transducer for receiving an echo of the signal transmitted by the transmitting transducer; and
a circuit coupled to the transmitting and receiving transducers for providing an electrical signal to the transmitting transducer to generate the signal and for receiving an electrical signal from the receiving transducer indicative of the echo; the circuit including a processor for processing the signal indicative of the echo to determine if an object is present in the pool of liquid.

2. The apparatus of claim 1, wherein the circuit determines a time window for a first echo signal to be received after reflection off a wall of the pool of liquid and detects a second echo signal before receipt of the first echo signal if an object is present in the pool of liquid.

3. The apparatus of claim 1, wherein the at least one transmitting transducer and the at least one receiving transducer comprise at least two transducers each comprising a single transducer operated successively in transmitting and receiving modes.

4. The apparatus of claim 2, wherein the circuit comprises:
a signal generator for generating a transmit signal for the at least one transmitting transducer;
a receiver for receiving a signal from the at least one receiving transducer;
a signal processor for receiving an output from the receiver and for determining if the echo signal has been received from an object in the pool of liquid prior to the end of the time window; and
an alarm generator coupled to the signal processor for generating an alarm if an echo signal has been received in the time window

5. The apparatus of claim 4, further wherein the signal processor comprises a counter for counting a predetermined number of echo signals from an object in the pool of liquid and generating an output signal only if the predetermined number of echo signals are counted.

6. The apparatus of claim 4, wherein the at least one transmitting transducer comprises at least two transmitting transducers and the at least one receiving transducer comprises at least two receiving transducers.

7. The apparatus of claim 6, wherein the at least two transmitting transducers and the at least two receiving transducers comprise at least two transducers, with each transducer comprising a transducer that operates in both a transmitting mode and in a receiving mode.

8. The apparatus of claim 6, wherein the at least two transmitting transducers generate different frequency signals.

9. The apparatus of claim 8, further comprising a filter for each receiving transducer whereby each filter passes only a frequency generated by a selected transmitting transducer.

10. The apparatus of claim 9, further comprising a duplexer coupled to each transducer whereby the transducer successively operates in a transmit and a receive mode.

11. The apparatus of claim 10, further comprising an OR circuit in the signal processor whereby if any one of the transducers receive an echo signal from an object in the pool of liquid, a signal is provided to the alarm generator to generate an alarm.

12. The apparatus of claim 1, wherein the at least one transmitting transducer and the at least one receiving transducer are located in at least one corner of a rectangular pool of liquid.

13. The apparatus of claim 1, wherein the at least one transmitting transducer and the at least on receiving transducer are located at at least one end of a rectangular pool of liquid.

14. The apparatus of claim 6, wherein the at least two transmitting transducers and the at least two receiving transducers are located at opposite ends of a rectangular pool of liquid.

15. The apparatus of claim 1, wherein the circuit comprises a fish finder sonic and ultrasonic device and the at least one transmitting transducer comprises at least one transducer arranged to transmit a sonic or ultrasonic signal into the pool of liquid such that the sonic or ultrasonic signal is radiated parallel to a top surface of the pool of liquid.

16. The apparatus of claim 15, wherein the at least one transmitting transducer an the at least one receiving transducer comprise a single transducer operated successively in transmitting and receiving modes.

17. The apparatus of claim 15, wherein the fish finder sonic or ultrasonic device comprises a signal processor for processing the signal indicative of an echo to discriminate the size of an object in the pool of liquid.
